(19) United States
(12) Patent Application Publication
(10) Pub. No.: US 2009/0146001 A1
(43) Pub. Date: Jun. 11, 2009

(54) Power transmission system for an aircraft

(76) Inventor: Shigetada Taya, Yokohama City (JP)

Correspondence Address: TROXELL LAW OFFICE PLLC, SUITE 1404, 5205 LEESBURG PIKE, FALLS CHURCH, VA, 22041, US

(21) Appl. No.: 12/000,313

(22) Filed: Dec. 11, 2007

(51) Int. Cl. B64C 27/12

(52) U.S. Cl. 244/60

(57) ABSTRACT

A power transmission system for an aircraft is disclosed. A driving motor having a driving axle is provided inside an aircraft. The driving axle has a gear part and a wheel part. They drive a gear disk and a belt, respectively, to rotate the rotor and the tail rotor. The invention simplifies the power transmission structure of the aircraft.

### BACKGROUND OF THE INVENTION

1. Field of Invention

The invention relates to a power transmission system for an aircraft and, in particular, to a power transmission system that uses a simple mechanism to rotate the rotor and tail rotor of the aircraft.

2. Related Art

As shown in FIG. 2, an aircraft 9 has a rotor 92 above its body 91 and a tail rotor 93 pivotally installed at its tail. The rotor 92 is pivotally connected to the body 91 via a rotating axis 921. The body 91 is provided with a driving motor 94 with a tooth-like driving axle 941 for driving a first gear disk 95 coaxially disposed with the rotor 92. The first gear disk 95 matches with the driving axle 941 and rotates the rotor 92. A second gear disk 96 is coaxially disposed with the first gear disk 95 inside the body 91 to rotate a driven gear 97. The driven gear 97 drives a transmission belt 98 whose other end is connected to rotate the tail rotor 93.

To take apart or assemble the above-mentioned transmission system, one has to remove or install each individual component. It is time-consuming and costs money. It is a purpose of the invention to simplify the transmission system components to reduce the time and cost for assembling or disassembling it.

### SUMMARY OF THE INVENTION

An objective of the invention is to provide a power transmission system for an aircraft that solves the above-mentioned problems. It uses a simpler transmission mechanism to rotate the rotor and the tail rotor. It is thus easier to assemble/disassemble the aircraft, reducing the time and cost.

To achieve the above objective, the disclosed power transmission system for an aircraft includes: a body that has a rotor above it and a tail rotor at its tail, wherein the rotor is pivotally disposed on one end of a rotating axle and the other end of the rotating axle is provided with a gear disk and fixed to the body. The features of the invention are as follows. A driving motor having a driving axle is fixed to the body. The driving axle has a gear part and a wheel part. The gear part matches with the gear disk to rotate the rotor. The wheel part is mounted with a belt for rotating the tail rotor.

### BRIEF DESCRIPTION OF THE DRAWINGS

The invention will become more fully understood from the detailed description given herein below illustration only, and thus is not limitative of the present invention, and wherein:

FIG. 1 is a planar view of the disclosed power transmission system; and

FIG. 2 is a planar view of the power transmission system for an aircraft in the prior art.

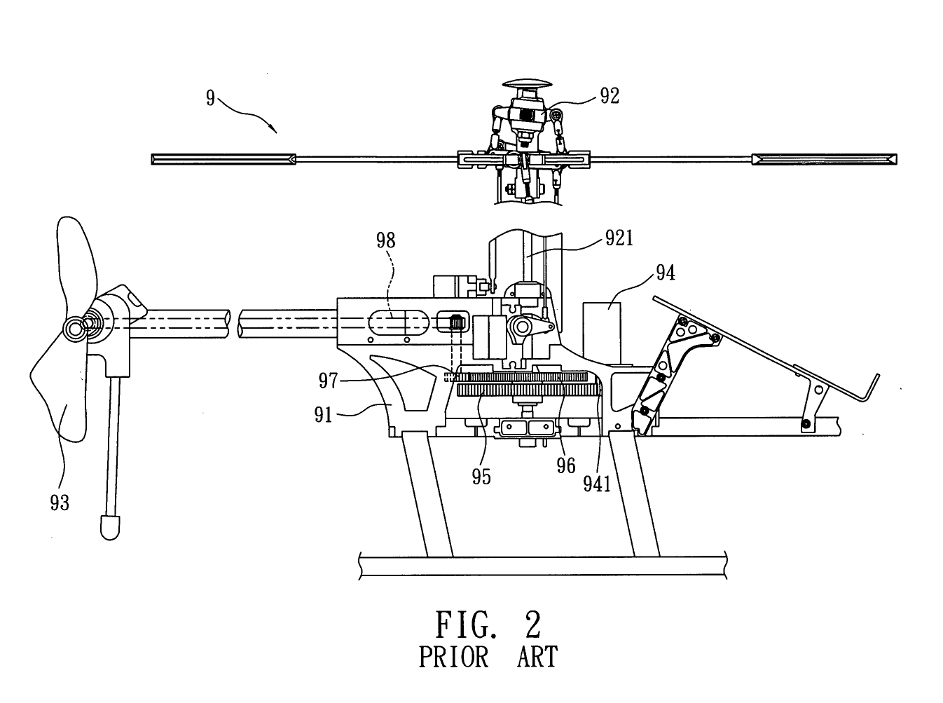

### DETAILED DESCRIPTION OF THE INVENTION

The present invention will be apparent from the following detailed description, which proceeds with reference to the accompanying drawings, wherein the same references relate to the same elements.

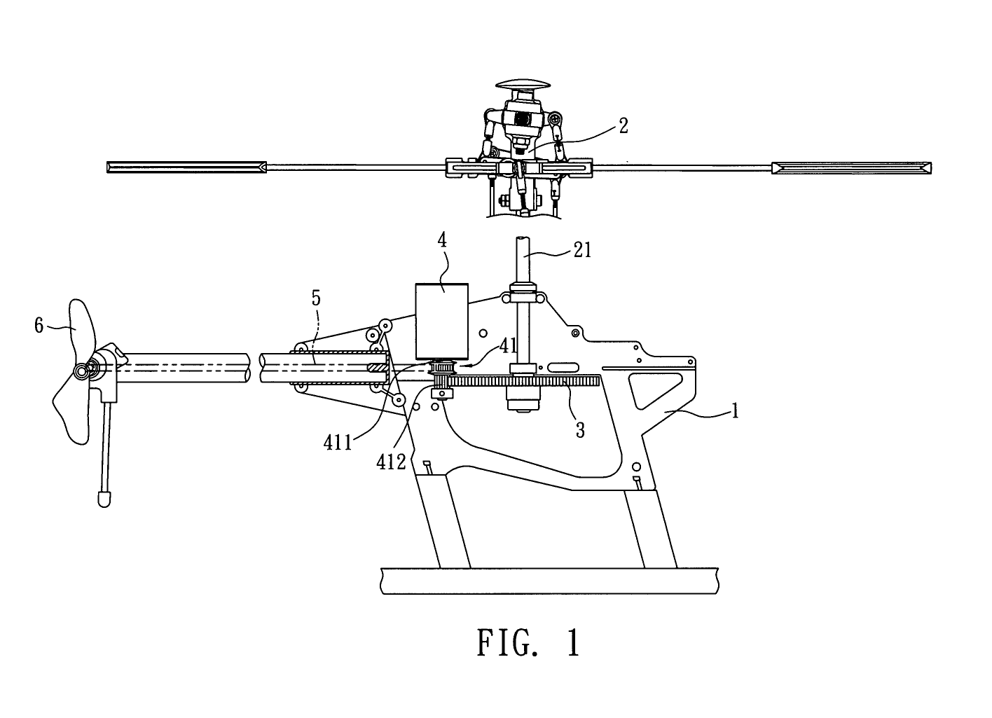

Please refer to FIG. 1 for an embodiment of the invention. The structure disclosed in this particular embodiment is only an example and should not be used to restrict the invention defined by the claims.

This embodiment provides a power transmission system for an aircraft. The aircraft herein refers to a rotorcraft. It has a body 1 for fixing various components. A rotor 2 is provided above the body 1. A vertical rotating axle 21 is pivotally connected to the front end of the body 1 using its one end. The rotating axle 21 is connected with a gear disk 3 in the vicinity of the body 1 for transverse transmission.

A driving motor 4 is fixed between the rotating axle 21 and the tail inside the body 1. The driving motor 4 has a driving axle 41 pivotal along the bottom direction of the body 1. The driving axle 41 has a wheel part 411 in its front part. Its rear part adjacent to the wheel part 411 is a gear part 412. The teeth of the gear part 412 match with the teeth of the gear disk 3 at the bottom of the rotating axle 21. The wheel part 411 is mounted with a belt 5 whose other end is connected with a tail rotor 6 at the tail of the body 1.

According to the above-mentioned structure and connecting relation, the driving axle 41 rotates when the driving motor 4 runs. In this case, the wheel part 411 in the front part drives the tail rotor 6 on the other end of the belt 5 into rotation. At the same time, the gear part 412 in the rear part of the driving axle 41 also rotates the rotor 2 coaxially connected to the gear disk 3 at the bottom of the rotating axle 21.

It is not difficult to see that the invention has a simpler structure than the conventional power transmission system. The rotor 2 and the tail rotor 6 are rotated at the same time with a gear disk 3 and a belt 5 without involving other components. Therefore, the disclosed structure has the advantages of lighter weight, less material, less assembly time, and thus less cost. The user can readily assemble/disassemble the disclosed power transmission system. The transmission power loss of the aircraft can also be reduced due to the simpler structure.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A power transmission system for an aircraft having a body, a rotating axle fixed to the body, a rotor above the body and pivotally connected to one end of a rotating axle, a tail rotor at the tail of the body, and a gear disk connected to the other end of the rotating axle, the power transmission system comprising:
a driving motor, which has a driving axle that has a gear part and a wheel part; wherein the gear part matches with the gear disk to rotate the rotor, and the wheel part is mounted with a belt to rotate the tail rotor.
